(19) United States
(12) Patent Application Publication
(10) Pub. No.: US 2026/0081079 A1
(43) Pub. Date: Mar. 19, 2026

(54) MULTILAYER CERAMIC CAPACITOR

(71) Applicant: Murata Manufacturing Co., Ltd., Nagaokakyo-shi (JP)

(72) Inventors: Kenichi HAYASHI, Nagaokakyo-shi (JP); Toshihiro SUZUKI, Nagaokakyo-shi (JP); Shigeyuki HORIE, Nagaokakyo-shi (JP)

(73) Assignee: Murata Manufacturing Co., Ltd., Nagaokakyo-shi (JP)

(21) Appl. No.: 19/396,368

(22) Filed: Nov. 21, 2025

Related U.S. Application Data
(63) Continuation of application No. PCT/JP2024/014056, filed on Apr. 5, 2024.

(30) Foreign Application Priority Data
Jun. 6, 2023 (JP) 2023-093072

(51) Int. Cl. H01G 4/232; H01G 4/30

(52) U.S. Cl. CPC H01G 4/2325; H01G 4/30

(57) ABSTRACT

A multilayer ceramic capacitor includes a multilayer body and external electrodes on first and second end surfaces. Each external electrode has a Cu base layer, a Ni plating layer in contact with the Cu base layer that covers the Cu base layer, and a Sn plating layer that covers the Ni plating layer. When a ridge part is defined as a portion where two surfaces of the multilayer body intersect, the thickness of the Cu base layer at the ridge part of the multilayer body is less than the thickness of the Cu base layer at a main surface, at a side surface, and at an end surface. The coverage of the Cu base layer at the ridge part is not less than 85%. The difference between the coverage of the Cu base layer at the ridge part and at the main surface and the side surface is within ±5%.

### CROSS-REFERENCE TO RELATED APPLICATIONS

The present application is a continuation of PCT International Application No. PCT/JP2024/014056, filed on Apr. 5, 2024, which claims priority to Japanese patent application JP 2023-093072, filed Jun. 6, 2023, the entire contents of each of which being incorporated herein by reference.

### TECHNICAL FIELD

The present disclosure relates to a multilayer ceramic capacitor.

### BACKGROUND ART

The external electrodes of conventional multilayer ceramic capacitors mainly include a Cu base electrode layer provided on a ceramic base body, a Ni plated layer provided on the Cu base electrode layer, and a Sn plated layer provided on the Ni plated layer. Generally, the Ni plated layer and the Sn plated layer are provided by an electrolytic plating method. The Ni plated layer provided on the Cu base electrode layer functions to prevent the Cu base electrode layer from dissolving into molten solder (solder leaching) when the multilayer ceramic capacitor is mounted by solder on a substrate.

### CITATION LIST

### Patent Document

Patent Document 1: Japanese Unexamined Patent Application, Publication No. 2019-160963

### SUMMARY

### Problems to be Solved

The Cu base electrode layer provided on the ceramic base body in Patent Document 1 is provided by a dipping method, screen printing method, roller coating method, or the like. Therefore, due to the characteristics of the printing method, the thickness of the Cu base electrode layer provided at ridge portions where any two surfaces among the main surface, lateral surface, and end surface of the ceramic base body intersect may be thinner than surface regions other than the ridge portions. When the Cu base electrode layer is thinly provided at the ridge portions, it is difficult to continuously provide the Cu base electrode layer, and there may be locations at some parts of the ridge portions that are not covered by the Cu base electrode layer. Since the Ni plated layer provided on the Cu base electrode layer is provided by an electrolytic plating method, the Ni plated layer is not provided at locations where the metallic Cu base electrode layer is not provided at some portions of the ridge portions. Therefore, there is a problem that solder leaching of the Cu base electrode layer cannot be prevented.

Accordingly, the present disclosure is directed to providing multilayer ceramic capacitors that are each able to suppress solder leaching occurring at the ridge portions of the ceramic base body.

### Means for Solving the Problems

A multilayer ceramic capacitor according to an embodiment includes: a multilayer body including a plurality of dielectric layers and a plurality of internal electrode layers that are laminated, a first main surface and a second main surface opposed to each other in a lamination direction, a first lateral surface and a second lateral surface opposed to each other in a width direction orthogonal to the lamination direction, and a first end surface and a second end surface opposed to each other in a length direction orthogonal to the lamination direction and the width direction; and external electrodes respectively on the first end surface and the second end surface, in which each of the external electrodes includes a Cu base layer, a Ni plated layer in contact with the Cu base layer and covering the Cu base layer, and a Sn plated layer covering the Ni plated layer, when portions where two surfaces of the multilayer body meet are each defined as a ridge portion, a thickness of the Cu base layer at the ridge portion of the multilayer body is smaller than a thickness of the Cu base layer at each of the main surfaces, the lateral surfaces and the end surfaces, a coverage ratio of the Cu base layer at the ridge portion is 85% or more, and a difference between the coverage ratio of the Cu base layer at the ridge portion and a coverage ratio of the Cu base layer at each of the main surfaces and the lateral surfaces falls within ±5%.

### Effects

According to the present disclosure, it is possible to provide multilayer ceramic capacitors that are each able to suppress solder leaching of the Cu base layer.

### BRIEF DESCRIPTION OF THE DRAWINGS

FIG. 1 is a perspective view of a multilayer ceramic capacitor of the present embodiment. FIG. 2 is a cross-sectional view taken along the line Y-Y in FIG. 1. FIG. 3 is a cross-sectional view taken along the line X-X in FIG. 1.

### DETAILED DISCLOSURE

### Outer Shape of Multilayer Ceramic Capacitor

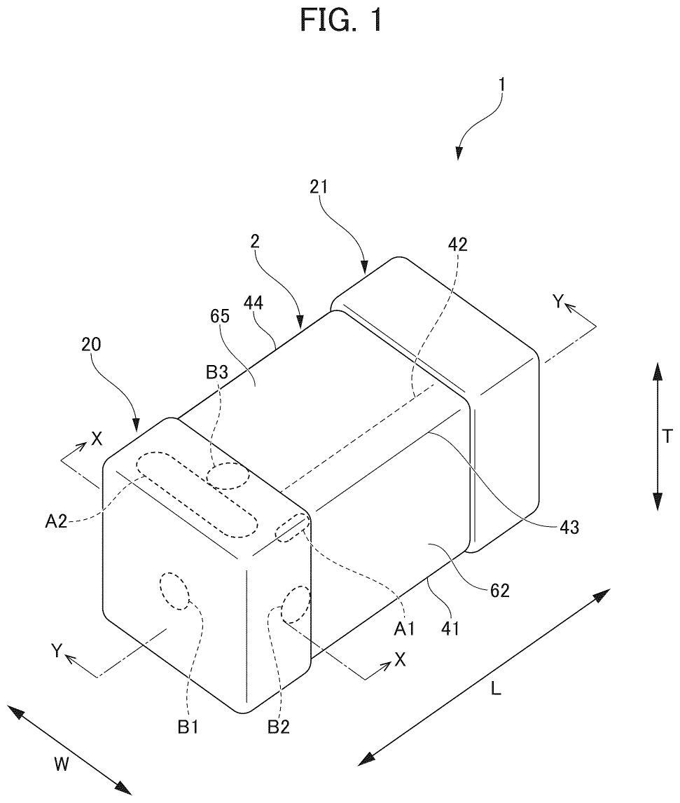

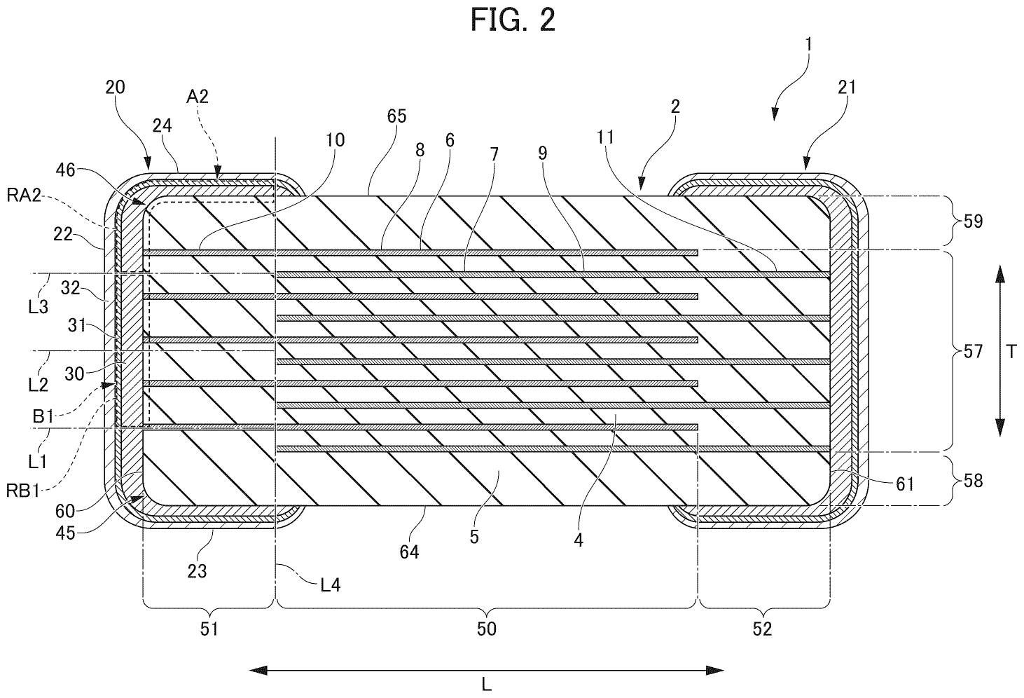

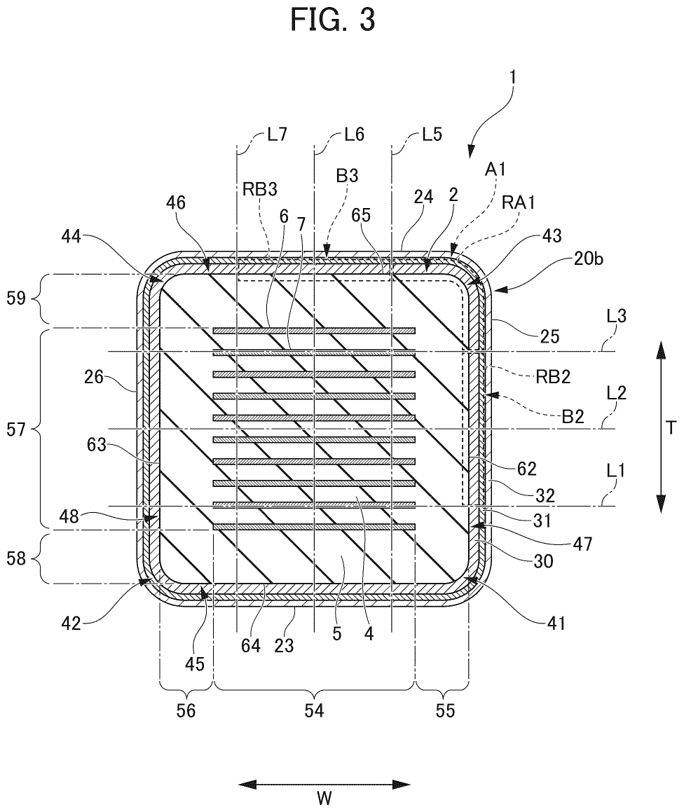

An outline of the appearance of a multilayer ceramic capacitor 1 will be described with reference to FIG. 1. FIG. 1 is a perspective view showing the multilayer ceramic capacitor 1 of the present embodiment. The multilayer ceramic capacitor 1 includes a multilayer body 2 and two external electrodes. The two external electrodes include a first external electrode 20 and a second external electrode 21.

### Definitions of Directions

The drawings appropriately show the L direction, W direction, and T direction. The L direction refers to the length direction L of the multilayer ceramic capacitor 1. The W direction refers to the width direction W of the multilayer ceramic capacitor 1. The T direction refers to the lamination direction T of the multilayer ceramic capacitor 1. Accordingly, the cross section shown in FIG. 2 is referred to as an LT cross section. In addition, the cross section shown in FIG. 3 is referred to as a WT cross section. The length direction L, the width direction W, and the lamination direction T are not necessarily orthogonal to each other, but may be in a relationship intersecting each other.

### Outer Shape of Multilayer Body

The multilayer body 2 has a substantially rectangular parallelepiped shape. The multilayer body 2 includes two end surfaces, two lateral surfaces, and two main surfaces. The end surfaces are opposed to each other in the length direction L. The lateral surfaces are opposed to each other in the width direction W. The main surfaces are opposed to each other in the lamination direction T. The two end surfaces include a first end surface 60 and a second end surface 61. The two lateral surfaces include a first lateral surface 62 and a second lateral surface 63. The two main surfaces include a first main surface 64 and a second main surface 65. FIG. 1 shows the first lateral surface 62 and the second main surface 65.

### Ridge Portions

Portions where two surfaces of the multilayer body 2 intersect are each defined as a ridge portion. Portions where three surfaces of the multilayer body 2 intersect are each defined as a corner portion. Among the ridge portions, a portion where the first main surface 64 and the first lateral surface 62 intersect is defined as a first length direction ridge portion 41, a portion where the first main surface 64 and the second lateral surface 63 intersect is defined as a second length direction ridge portion 42, a portion where the second main surface 65 and the first lateral surface 62 intersect is defined as a third length direction ridge portion 43, and a portion where the second main surface 65 and the second lateral surface 63 intersect is defined as a fourth length direction ridge portion 44.

Furthermore, among the ridge portions, a portion where the first end surface 60 and the first main surface 64 intersect is defined as a first width direction ridge portion 45, and a portion where the first end surface 60 and the second main surface 65 intersect is defined as a second width direction ridge portion 46. In addition, a portion where the first end surface 60 and the first lateral surface 62 intersect is defined as a first height direction ridge portion 47, and a portion where the first end surface 60 and the second lateral surface 63 intersect is defined as a second height direction ridge portion 48. These ridge portions are not shown in FIG. 1, but are shown in FIG. 2 or FIG. 3.

In addition, the ridge portions and corner portions of the multilayer body 2 may be rounded. The size of the multilayer body 2 is not particularly limited.

### Internal Configuration of Multilayer Body (LT Cross Section)

The configuration of the multilayer body 2 will be described with reference to cross-sectional views of the multilayer body 2. FIG. 2 is a cross-sectional view taken along the line Y-Y of FIG. 1, showing an LT cross section of the multilayer ceramic capacitor 1. The multilayer body 2 includes a plurality of dielectric layers and a plurality of internal electrode layers. The plurality of dielectric layers and the plurality of internal electrode layers are laminated in the lamination direction T. Before describing the dielectric layers and internal electrode layers, the division of the multilayer body 2 in the lamination direction T will be described. This is because the arrangement of the dielectric layers and internal electrode layers differs depending on the division.

### Inner Layer Portion and Outer Layer Portions

The multilayer body 2 can be divided into an inner layer portion 57 and two outer layer portions in the lamination direction T. The two outer layer portions include a first outer layer portion 58 and a second outer layer portion 59. The first outer layer portion 58 and the second outer layer portion 59 are located at positions sandwiching the inner layer portion 57 in the lamination direction T. A plurality of dielectric layers and a plurality of internal electrode layers are provided in the inner layer portion 57. Only dielectric layers are provided in the first outer layer portion 58 and the second outer layer portion 59.

### Inner Layer Dielectric Layers

The dielectric layers provided in the inner layer portion 57 are defined as inner layer dielectric layers 4.

### Internal Electrode Layers

The internal electrode layers include first internal electrode layers 6 and second internal electrode layers 7. The first internal electrode layers 6 refer to internal electrode layers connected to the first external electrode 20. The second internal electrode layers 7 refer to internal electrode layers connected to the second external electrode 21. The first internal electrode layers 6 extend from the first end surface 60 toward the second end surface 61. The second internal electrode layers 7 extend from the second end surface 61 toward the first end surface 60.

In the inner layer portion 57, the first internal electrode layers 6 and the second internal electrode layers 7 are opposed to each other with the inner layer dielectric layers 4 interposed therebetween. Electrostatic capacitance is formed in the inner layer portion 57. Therefore, the inner layer portion 57 is a portion that substantially functions as a capacitor in the multilayer body 2. Thus, the inner layer portion 57 is also referred to as an effective portion.

### Outer Layer Portions

The first outer layer portion 58 is an outer layer portion located adjacent to the first main surface 64 of the multilayer body 2 among the two outer layer portions. Specifically, the first outer layer portion 58 is a portion between the first main surface 64, and the first internal electrode layer 6 or the second internal electrode layer 7 closest to the first main surface 64 among the first internal electrode layers 6 and the second internal electrode layers 7.

The second outer layer portion 59 is an outer layer portion located adjacent to the second main surface 65 of the multilayer body 2 among the two outer layer portions. Specifically, the second outer layer portion 59 is a portion between the second main surface 65, and the first internal electrode layer 6 or the second internal electrode layer 7 closest to the second main surface 65 among the first internal electrode layers 6 and the second internal electrode layers 7.

No internal electrode layers are provided in the first outer layer portion 58 and the second outer layer portion 59. Only dielectric layers are provided in the first outer layer portion 58 and the second outer layer portion 59. The dielectric layers provided in the first outer layer portion 58 or the second outer layer portion 59 are defined as outer layer dielectric layers 5. The first outer layer portion 58 and the second outer layer portion 59 function as protective layers for the inner layer portion 57.

### Number of Dielectric Layers

The total number of inner layer dielectric layers 4 and outer layer dielectric layers 5 laminated in the multilayer body 2 can be, for example, 5 or more and 2000 or less.

### Materials of Dielectric Layers

As the materials of the inner layer dielectric layers 4 and the outer layer dielectric layers 5, for example, a dielectric ceramic including BaTiO₃, CaTiO₃, SrTiO₃, CaZrO₃ or the like as a main component can be used. Furthermore, materials in which subcomponents such as a Mn compound, Fe compound, Cr compound, Co compound, or Ni compound are added to these main components may be used.

### Thickness of Dielectric Layers

The thickness of each layer of the inner layer dielectric layers 4 or the outer layer dielectric layers 5 can be, for example, 0.3 μm or more and 0.6 μm or less.

### Counter Portion and Extension Portion

The first internal electrode layers 6 each include a first counter electrode portion 8 and a first extension electrode portion 10. The second internal electrode layers 7 each include a second counter electrode portion 9 and a second extension electrode portion 11. The first counter electrode portion 8 is a portion of the first internal electrode layer 6 that is opposed to the second internal electrode layer 7 in the lamination direction T. The second counter electrode portion 9 is a portion of the second internal electrode layer 7 that is opposed to the first internal electrode layer 6 in the lamination direction T.

The first extension electrode portion 10 is a portion of the first internal electrode layer 6 extending from the first counter electrode portion 8 toward the first end surface 60 of the multilayer body 2. The second extension electrode portion 11 is a portion of the second internal electrode layer 7 extending from the second counter electrode portion 9 toward the second end surface 61 of the multilayer body 2.

### L Electrode Counter Portion

The segmentation of the multilayer body 2 in the length direction L will be described. The multilayer body 2 can be divided into an L electrode counter portion 50, a first L gap portion 51, and a second L gap portion 52 in the length direction L. The L electrode counter portion 50 corresponds to a portion where the first internal electrode layers 6 and the second internal electrode layers 7 are opposed to each other in the lamination direction T. Capacitance is formed in the L electrode counter portion 50. Thus, the L electrode counter portion 50 is also referred to as an effective portion.

### L Gap Portion

The first L gap portion 51 and the second L gap portion 52 are portions in the length direction L of the multilayer body 2 where the first internal electrode layers 6 and the second internal electrode layers 7 are not opposed to each other in the lamination direction T. The first L gap portion 51 corresponds to a portion between the L electrode counter portion 50 and the first end surface 60. The second L gap portion 52 corresponds to a portion between the L electrode counter portion 50 and the second end surface 61.

In the first L gap portion 51, the first internal electrode layers 6 are provided in the lamination direction T, but the second internal electrode layers 7 are not provided. In the second L gap portion 52, the second internal electrode layers 7 are provided in the lamination direction T, but the first internal electrode layers 6 are not provided. The first L gap portion 51 functions as an extension portion of each of the first counter electrode portions 8 toward the first end surface 60. The second L gap portion 52 functions as an extension portion of each of the second counter electrode portions 9 toward the second end surface 61.

The length of each of the first L gap portion 51 and the second L gap portion 52 in the length direction L can be, for example, 10% or more and 30% or less of the length of the multilayer body 2 in the length direction L. Further, the length of each of the first L gap portion 51 and the second L gap portion 52 in the length direction L can be, for example, 5 μm or more and 30 μm or less.

### Number of Internal Electrode Layers

The total number of the first internal electrode layers 6 and the second internal electrode layers 7 can be, for example, ten layers or more and 2000 layers or less.

### Thickness of Internal Electrode Layer

The thickness of each layer of the first internal electrode layers 6 or the second internal electrode layers 7 can be, for example, 0.1 μm or more and 5.0 μm or less, e.g., 0.2 μm or more and 2.0 μm or less.

### Material of Internal Electrode Layers

The material of the first internal electrode layers 6 and the second internal electrode layers 7 can be, for example, metals such as Ni, Cu, Ag, Pd, and Au, or alloys such as an alloy of Ni and Cu or an alloy of Ag and Pd. The material of the first internal electrode layers 6 and the second internal electrode layers 7 may additionally include dielectric particles having the same composition system as the ceramic included in the inner layer dielectric layers 4 or the outer layer dielectric layers 5.

### External Electrodes

The multilayer body 2 is provided with the two external electrodes of the first external electrode 20 and the second external electrode 21. The first external electrode 20 is an external electrode mainly provided on the first end surface 60 of the multilayer body 2. The first external electrode 20 is electrically connected to the first internal electrode layers 6. The second external electrode 21 is an external electrode mainly provided on the second end surface 61 of the multilayer body 2. The second external electrode 21 is electrically connected to the second internal electrode layers 7.

### External Electrode on Each Surface

The first external electrode 20 extends from the first end surface 60 to a portion of each of the first main surface 64, the second main surface 65, the first lateral surface 62, and the second lateral surface 63. Similarly, the second external electrode 21 extends from the second end surface 61 to a portion of each of the first main surface 64, the second main surface 65, the first lateral surface 62, and the second lateral surface 63.

Regarding the first external electrode 20, the first external electrode 20 on the first end surface 60 is referred to as a first end surface external electrode 22, the first external electrode 20 on the first main surface 64 is referred to as a first main surface external electrode 23, the first external electrode 20 on the second main surface 65 is referred to as a second main surface external electrode 24, the first external electrode 20 on the first lateral surface 62 is referred to as a first lateral surface external electrode 25, and the first external electrode 20 on the second lateral surface 63 is referred to as a second lateral surface external electrode 26. Among these external electrodes, FIG. 2 shows the first end surface external electrode 22, the first main surface external electrode 23, and the second main surface external electrode 24. Other external electrodes are shown in FIG. 3. The second external electrode 21 is similar to the first external electrode 20. A description of the second external electrode 21 is omitted.

### Layer Configuration of External Electrode

The layer configuration of each of the external electrodes will be described based on FIG. 2. The layer configuration of the first external electrode 20 and the layer configuration of the second external electrode 21 are similar. Here, the layer configuration of the external electrode will be described using the first external electrode 20 as an example. The first external electrode 20 includes a Cu base layer 30, a Ni plated layer 31, and a Sn plated layer 32. These layers are laminated in the order of the Cu base layer 30, the Ni plated layer 31, and the Sn plated layer 32 from the first end surface 60 of the multilayer body 2.

### Cu Base Layer

The Cu base layer 30 is mainly provided on the first end surface 60 of the multilayer body 2 and covers the first end surface 60. The Cu base layer 30 extends from the first end surface 60 to a portion of the first main surface 64, a portion of the second main surface 65, a portion of the first lateral surface 62, and a portion of the second lateral surface 63.

The Cu base layer 30 is a layer including metal and a glass component. The metal includes at least one selected from, for example, Cu, Ni, Ag, Pd, Ag—Pd alloy, Au, and the like. The glass component includes at least one selected from B, Si, Ba, Mg, Al, Li, and the like.

Regarding the thickness of the Cu base layer 30, the thickness of the Cu base layer 30 at the ridge portions is smaller than the thickness of the Cu base layer 30 at surface regions of the main surfaces, lateral surfaces, and end surfaces. As used herein, a “surface region” refers to an area on a main, lateral, or end surface that is spaced apart from any ridge portion, and is generally representative of the central or non-edge portion of that surface.

In addition, it the thickness of the Cu base layer 30 may be 10 μm or more, particularly at the ridge portions. By sufficiently securing the thickness of the Cu base layer 30 at the ridge portions where the thickness of the Cu base layer 30 tends to be small and solder leaching is likely to occur, it is possible to further suppress the occurrence of solder leaching described later.

### Ni Plated Layer

The Ni plated layer 31 is a plated layer provided to cover the Cu base layer 30. The Ni plated layer 31 is also referred to as an inner plated layer. When mounting the multilayer ceramic capacitor 1 on a substrate or the like, solder is used. The Ni plated layer 31 can suppress the Cu base layer 30 from being eroded by solder due to the solder leaching described later.

The Ni plated layer 31 is formed with a substantially uniform film thickness relative to the Cu base layer 30. As a result, the ratio of the thickness of the Ni plated layer 31 to the thickness of the Cu base layer 30 at the ridge portions, that is, the thickness of the Ni plated layer 31/the thickness of the Cu base layer 30, is larger than the ratio of the thickness of the Ni plated layer 31 to the thickness of the Cu base layer 30 at the main surfaces, lateral surfaces, and end surfaces. This is because the thickness of the Cu base layer 30 at the ridge portions is smaller than the thickness of the Cu base layer 30 at the main surfaces, lateral surfaces, and end surfaces.

In addition, the thickness of the Ni plated layer 31 may be 2.0 μm or more, particularly at the ridge portions. This makes it possible to sufficiently secure the thickness of the Ni plated layer 31 at the ridge portions where the thickness of the Cu base layer 30 is relatively smaller compared to other surfaces. This makes it possible to further suppress the occurrence of solder leaching.

### Sn Plated Layer

The Sn plated layer 32 is a plated layer provided to cover the Ni plated layer 31. The Sn plated layer 32 is also referred to as an outer plated layer. The Sn plated layer 32 can improve the wettability of solder when mounting the multilayer ceramic capacitor 1. This makes it possible to facilitate the mounting of the multilayer ceramic capacitor 1.

The thickness of each of the Ni plated layer 31 and the Sn plated layer 32 may be, for example, 2.0 μm or more. By setting the thickness of the Ni plated layer to 2.0 μm or more, it is possible to further suppress the Cu base layer 30 from being eroded by solder.

### Internal Configuration of Multilayer Body (WT Cross Section)

Based on FIG. 3, the internal configuration of the multilayer body 2 when viewed from the length direction L will be described. FIG. 3 is a WT cross-sectional view of the multilayer ceramic capacitor 1. The multilayer body 2 can be divided in the width direction W into a W electrode counter portion 54, a first W gap portion 55, and a second W gap portion 56.

### W Electrode Counter Portion

The W electrode counter portion 54 corresponds to a portion where the first internal electrode layers 6 and the second internal electrode layers 7 are opposed to each other in the lamination direction T. Capacitance is formed in the W electrode counter portion 54. Therefore, the W electrode counter portion 54 is also referred to as an effective portion.

### W Gap Portion

The first W gap portion 55 and the second W gap portion 56 are portions where neither the first internal electrode layers 6 nor the second internal electrode layers 7 are provided in the width direction W of the multilayer body 2. The first W gap portion 55 is a portion between the W electrode counter portion 54 and the first lateral surface 62 in the width direction W of the multilayer body 2. The second W gap portion 56 is a portion between the W electrode counter portion 54 and the second lateral surface 63 in the width direction W of the multilayer body 2.

The first W gap portion 55 and the second W gap portion 56 are provided to sandwich the W electrode counter portion 54. The first W gap portion 55 and the second W gap portion 56 function as protective layers for the first internal electrode layers 6 and the second internal electrode layers 7.

The length of each of the first W gap portion 55 and the second W gap portion 56 in the width direction W can be, for example, 20% or more and 30% or less of the length of the multilayer body 2 in the width direction W. Further, the length of each of the first W gap portion 55 and the second W gap portion 56 in the width direction W can be, for example, 5 μm or more and 50 μm or less.

### Size of Multilayer Ceramic Capacitor

The size of the multilayer ceramic capacitor 1 is not particularly limited. The size of the multilayer ceramic capacitor 1 can be as follows, for example. The dimension of the multilayer ceramic capacitor 1 including the multilayer body 2 and the external electrodes in the length direction L is defined as the L dimension. The L dimension may be 0.25 mm or more and 1.0 mm or less. The dimension of the multilayer ceramic capacitor 1 including the multilayer body 2 and the external electrodes in the lamination direction T is defined as the T dimension. The T dimension may be 0.125 mm or more and 0.5 mm or less. The dimension of the multilayer ceramic capacitor 1 including the multilayer body 2 and the external electrodes in the width direction W is defined as the W dimension. The W dimension may be 0.125 mm or more and 0.5 mm or less. The length of each portion of the multilayer body 2 and the external electrodes can be measured with a micrometer or an optical microscope.

### Terminal Configuration

In the present embodiment, the multilayer ceramic capacitor 1 has been described as an example of a two-terminal multilayer ceramic capacitor. However, the multilayer ceramic capacitor 1 is not limited to a two-terminal multilayer ceramic capacitor. The multilayer ceramic capacitor 1 can also be a multi-terminal multilayer ceramic capacitor having three or more terminals.

The multilayer ceramic capacitor 1 of the present embodiment is characterized by the coverage ratio of the Cu base layer 30 and the like. The multilayer ceramic capacitor 1 of the present embodiment can suppress solder leaching of the Cu base layer 30 by a simple means.

### Solder Leaching

Solder leaching will be described. When the multilayer ceramic capacitor 1 is mounted on a substrate or the like, Sn contained in the solder and Cu contained in the electrode layer containing Cu provided on the end surface of the multilayer ceramic capacitor 1, for example, Cu contained in the Cu base layer, may react due to the heat during solder bonding and produce a CuSn compound. The reaction between Sn contained in the solder and Cu in the electrode layer containing Cu in this manner is called solder leaching. Such solder leaching may impair the reliability of the electrical connection between the internal electrodes and the electrode layer containing Cu of the multilayer ceramic capacitor 1.

The inventors has found that, when the coverage ratio of the Cu base layer 30 is poor, deterioration of the ceramic base body due to the temperature during solder mounting and solder leaching of the Cu base layer 30 are likely to occur. Further, the inventor has found that the coverage ratio of the Cu base layer 30 tends to be poorer at the ridge portions compared to other portions of the multilayer body 2.

In the multilayer ceramic capacitor 1 of the present embodiment, the thickness of the Cu base layer 30 is small at the ridge portions and large at the main surfaces and lateral surfaces. Further, the coverage ratio of the Cu base layer 30 at the ridge portions is 85% or more. Furthermore, the difference between the coverage ratio of the Cu base layer 30 at the ridge portions and the coverage ratio of the Cu base layer 30 at the main surfaces and lateral surfaces falls within ±5%. With such a configuration, in the multilayer ceramic capacitor 1 of the present embodiment, solder leaching of the Cu base layer 30 is suppressed.

### Coverage Ratio

The coverage ratio will be described. The coverage ratio indicates, for example, in the Cu base layer 30, the ratio of the metal region to the region other than the metal region. As used herein, “coverage ratio” as used herein refers to the proportion of a cross-section of the Cu base layer 30 occupied by conductive metal, as opposed to voids or glass components. A higher coverage ratio indicates a denser, more continuous metallic layer. Specifically, the coverage ratio is calculated from the expression: coverage ratio=metal region/(metal region+region other than metal). Region other than the metal region refers to a region occupied b20y voids or glass. For example, if the coverage ratio at a ridge portion is 90%, a coverage ratio at a main surface that falls within ±5% would be between 85% and 95%. The metal region and the region other than metal can be determined, for example, by exposing a cross section by polishing as necessary, and observing it with an optical microscope or the like.

The present embodiment is characterized by the coverage ratio of the Cu base layer 30. Therefore, in the following description, unless otherwise specified, the coverage ratio indicates the coverage of the Cu base layer 30.

The coverage ratios at the following five portions will be described as the coverage ratios. The five portions refer to the coverage ratio A1 of the length direction ridge portion, the coverage ratio A2 of the width direction ridge portion, the coverage ratio B1 of the end surface, the coverage ratio B2 of the lateral surface, and the coverage ratio B3 of the main surface, shown in FIG. 1.

### Calculation Region of Coverage Ratio in WT Cross Section

The calculation region of the coverage ratio will be described. First, based on the WT cross-sectional view, the coverage ratio A1 of the length direction ridge portion, the coverage ratio B2 of the lateral surface, and the coverage ratio B3 of the main surface will be described. FIG. 3 shows the calculation regions of the coverage ratio A1 of the length direction ridge portion, the coverage ratio B2 of the lateral surface, and the coverage ratio B3 of the main surface enclosed by dotted lines. These calculation regions are determined based on the dividing lines when the multilayer body 2 is divided into four portions. FIG. 3 shows the dividing lines when the WT cross section of the multilayer body 2 is divided into four portions both in the lamination direction T and the width direction W. The dividing lines when the multilayer body 2 is divided into four portions in the lamination direction T are shown as dividing lines L1 to L3. In addition, the dividing lines when the multilayer body 2 is divided into four portions in the width direction W are shown as dividing lines L5 to L7.

### Calculation Region of Length Direction Ridge Portion

The calculation region of the coverage ratio A1 of the length direction ridge portion will be described using the third length direction ridge portion 43 as an example. The calculation region of the coverage ratio A1 of the length direction ridge portion is defined as a calculation region RA1. The calculation region RA1 is a portion including the Cu base layer 30 that exists in the region where the third length direction ridge portion 43 is present among the four regions divided by the dividing line L3 and the dividing line L5. This calculation region RA1 includes the Cu base layer 30 near the third length direction ridge portion 43.

Similarly, for the coverage ratio A1 of the length direction ridge portion of the first length direction ridge portion 41, the Cu base layer 30 near the first length direction ridge portion 41 included in the region divided by the dividing line L1 and the dividing line L5 corresponds to the calculation region RA1. In addition, for the coverage ratio A1 of the length direction ridge portion of the second length direction ridge portion 42, the Cu base layer 30 near the second length direction ridge portion 42 included in the region divided by the dividing line L1 and the dividing line L7 corresponds to the calculation region RA1. In addition, for the coverage ratio A1 of the length direction ridge portion of the fourth length direction ridge portion 44, the Cu base layer 30 near the fourth length direction ridge portion 44 included in the region divided by the dividing line L3 and the dividing line L7 corresponds to the calculation region RA1.

### Calculation Region on Lateral Surface

The coverage ratio B2 of the lateral surface will be described using the first lateral surface 62 as an example. The calculation region of the coverage ratio B2 of the lateral surface is defined as a calculation region RB2. The calculation region RB2 is a portion including the Cu base layer 30 on the first lateral surface 62 included in the region divided by the dividing line L1 and the dividing line L3. This calculation region RB2 includes the Cu base layer 30 that is near the first height direction ridge portion 47 and at the middle portion in the lamination direction T on the first lateral surface 62.

Similarly, for the coverage ratio B2 of the lateral surface on the second lateral surface 63, the portion including the Cu base layer 30 on the second lateral surface 63 included in the region divided by the dividing line L1 and the dividing line L3 corresponds to the calculation region RB2.

### Calculation Region on Main Surface

The coverage ratio B3 of the main surface will be described using the second main surface 65 as an example. The calculation region of the coverage ratio B3 of the main surface is defined as calculation region RB3. The calculation region RB3 is a portion including the Cu base layer 30 on the second main surface 65 included in the region divided by the dividing line L5 and the dividing line L7. This calculation region RB3 includes the Cu base layer 30 that is near the second width direction ridge portion 46 and at the middle portion in the width direction W on the second main surface 65.

Similarly, for the coverage ratio B3 of the main surface on the first main surface 64, the portion including the Cu base layer 30 on the first main surface 64 included in the region divided by the dividing line L5 and the dividing line L7 corresponds to the calculation region RB3.

The values of the coverage ratio A1 of the length direction ridge portion, the coverage ratio B2 of the lateral surface, and the coverage ratio B3 of the main surface will be described. In the multilayer ceramic capacitor 1 of the present embodiment, the coverage ratio A1 of the length direction ridge portion is 85% or more. The coverage ratio A1 of the length direction ridge portion may be 95% or more. In addition, the difference between the coverage ratio A1 of the length direction ridge portion and the coverage ratio B2 of the lateral surface falls within ±5% of the coverage ratio A1 of the length direction ridge portion. In addition, the difference between the coverage ratio A1 of the length direction ridge portion and the coverage ratio B3 of the main surface falls within ±5% of the coverage ratio A1 of the length direction ridge portion.

The coverage ratio B2 of the lateral surface and the coverage ratio B3 of the main surface may be equal to or substantially equal to the coverage ratio A1 of the length direction ridge portion. This indicates that the coverage ratio of the Cu base layer 30 is uniform on the first lateral surface 62, the second lateral surface 63, the first main surface 64, the second main surface 65, the first length direction ridge portion 41, the second length direction ridge portion 42, the third length direction ridge portion 43, and the fourth length direction ridge portion 44. In addition, “substantially equal” indicates, for example, cases where the difference falls within the range of error and they perform similar functions.

When the coverage ratio described above is represented by an expression, the coverage ratio may be 85%, e.g., 95%≤A1≈B2, B3.

### Calculation Region of Coverage Ratio in LT Cross-Section

Next, the coverage ratio A2 of the width direction ridge portion and the coverage ratio B1 of the end surface will be described based on the LT cross-section. FIG. 2 shows the calculation regions of the coverage ratio A2 of the width direction ridge portion and the coverage ratio B1 of the end surface.

These calculation regions are defined based on the dividing lines from dividing line L1 to dividing line L3 when the multilayer body 2 is divided into four portions in the lamination direction T, and the boundary line between the L electrode counter portion 50 and the first L gap portion 51. The boundary line between the L electrode counter portion 50 and the first L gap portion 51 is defined as a boundary line L4. Further, the dividing lines from dividing line L1 to dividing line L3 are the same as the dividing lines from dividing line L1 to dividing line L3 shown in FIG. 3 above.

### Calculation Region of Width Direction Ridge Portion

The calculation region of the coverage ratio A2 of the width direction ridge portion will be described using the second width direction ridge portion 46 as an example. The calculation region of the coverage ratio A2 of the width direction ridge portion is defined as a calculation region RA2. The calculation region RA2 is a portion including the Cu base layer 30 included in the region where the second width direction ridge portion 46 exists among the four regions divided by the dividing line L3 and the boundary line L4. This calculation region RA2 includes the Cu base layer 30 near the second width direction ridge portion 46.

Similarly, for the coverage ratio A2 of the width direction ridge portion of the first width direction ridge portion 45, the Cu base layer 30 near the first width direction ridge portion 45 included in the region divided by the dividing line L1 and the boundary line L4 corresponds to the calculation region RA2.

### Calculation Region on End Surface

The coverage ratio B1 of the end surface will be described using the first end surface 60 as an example. The calculation region of the coverage ratio B1 of the end surface is defined as calculation region RB1. The calculation region RB1 is a portion including the Cu base layer 30 on the first end surface 60 included in the region divided by the dividing line L1 and the dividing line L3. This calculation region RB1 includes the Cu base layer 30 at the surface region in the lamination direction T on the first end surface 60 located between the first and second width direction ridge portions 45, 46.

Similarly, for the coverage ratio B1 of the end surface on the second end surface 61, the portion including the Cu base layer 30 on the second end surface 61 included in the section divided by the dividing line L1 and the dividing line L3 corresponds to the calculation region RB1.

The values of the coverage ratio A2 of the width direction ridge portion and the coverage ratio B1 of the end surface will be described. In the multilayer ceramic capacitor 1 of the present embodiment, the coverage ratio A2 of the width direction ridge portion is 85% or more. The coverage ratio A2 of the width direction ridge portion may be 95% or more.

Further, the difference between the coverage ratio A2 of the width direction ridge portion and the coverage ratio B1 of the end surface may be within ±5% of the coverage ratio A2 of the width direction ridge portion. The coverage ratio B1 of the end surface may be equal to or substantially equal to the coverage ratio A2 of the width direction ridge portion.

The coverage ratio B1 of the end surface is equal to or substantially equal to the coverage ratio B3 of the main surface. In this case, the coverage ratio of the Cu base layer 30 becomes uniform on the first main surface 64, the second main surface 65, the first end surface 60, the first width direction ridge portion 45, and the second width direction ridge portion 46.

When the coverage ratio described above is represented by an expression, it may be 85%, e.g., 95%≤A2≈B1, B3.

Summarizing the calculated values of coverage ratio based on the LT cross-section of FIG. 2 and the calculated values of coverage ratio based on the WT cross-section of FIG. 3 described above, the coverage ratio A1 of the length direction ridge portion, the coverage ratio A2 of the width direction ridge portion, the coverage ratio B1 of the end surface, the coverage ratio B2 of the lateral surface, and the coverage ratio B3 of the main surface may all be 85% or more, e.g. 95% or more.

In addition, the coverage ratio A1 of the length direction ridge portion, the coverage ratio A2 of the width direction ridge portion, the coverage ratio B1 of the end surface, the coverage ratio B2 of the lateral surface, and the coverage ratio B3 of the main surface may be equal or substantially equal.

When the above form is represented by an expression, this may be 85%, e.g., 95%≤A1≈B1, B2, B3, or 85%, e.g., 95%≤A2≈B1, B2, B3.

### Manufacturing Method of Multilayer Ceramic Capacitor

A manufacturing method of the multilayer ceramic capacitor 1 will be described.

### Preparation of Multilayer Block

Ceramic green sheets and electrode paste for manufacturing internal electrode layers are prepared.

### Application of Paste

The electrode paste is applied to the ceramic green sheets in a desired pattern. The application of the paste to the ceramic green sheets can be performed by methods such as screen printing or gravure printing.

### Lamination

A predetermined number of ceramic green sheets on which no internal electrode layer pattern is printed are laminated. This produces a portion corresponding to one of the outer layer portions. On top of this, ceramic green sheets for manufacturing the inner layer portion to which paste has been applied are sequentially laminated. This laminates a portion corresponding to the inner layer portion 57. Furthermore, a predetermined number of ceramic green sheets for the other outer layer portion are laminated on top of that. This produces a multilayer sheet. The multilayer sheet is pressed in the lamination direction by a means such as hydrostatic pressing to produce a multilayer block.

### Preparation of Multilayer Chip

The multilayer block is cut to a predetermined size to cut out multilayer chips. At this time, the corner portions and ridge portions of the multilayer chips may be rounded by barrel polishing or the like.

### Firing

Next, the multilayer chips are fired to produce the multilayer body 2. The firing temperature may be 900° C. or more and 1400° C. or less, although it depends on the materials of the dielectric layers and internal electrode layers.

### External Electrodes

Next, external electrodes are formed. The external electrodes each include a Cu base layer 30, a Ni plated layer 31, and a Sn plated layer 32.

### Cu Base Layer

An electrically conductive paste that functions as the Cu base layer 30 is applied to the two end surfaces of the multilayer body 2, and fired to form the Cu base layer 30. Specifically, an electrically conductive paste including a glass component and metal is applied to the multilayer body 2 by a method such as dipping. After the application, a firing treatment is performed to form the Cu base layer 30. The temperature of the firing treatment may be 500° C. or more and 900° C. or less. In addition, the time of the firing treatment may be thirty minutes or more and two hours or less. In addition, the atmosphere of the firing treatment may be a reducing atmosphere including, for example, H₂O or H₂.

### Method for Uniformizing Coverage Ratio

An example of a method for uniformizing the coverage ratio of the Cu base layer 30 at each portion as described above will be described. A multilayer ceramic capacitor 1 on which the Cu base layer 30 is formed and before the Ni plated layer 31 is formed is defined as a pre-plating intermediate. The pre-plating intermediate is placed in a container, the container is rotated, and particles are sprayed into the rotating container. With such a configuration, the Cu base layer 30 is polished, and it is possible to uniformize the coverage ratio of the Cu base layer 30. Hereinafter, a specific description will be provided.

The coverage ratio of the Cu base layer 30 at the ridge portions in the pre-plating intermediate may be smaller than the coverage ratio of the Cu base layer 30 at portions other than the ridge portions. In this case, it is possible to uniformize the coverage ratio of the Cu base layer 30 by improving the coverage ratio of the Cu base layer 30 at the ridge portions.

In order to improve the coverage ratio of the Cu base layer 30 at the ridge portions, the container including the pre-plating intermediate is rotated, and sandblasting is performed by spraying fine particles of media such as zirconia or alumina, for example. With such a configuration, the blast media may be caused, i.e., the fine particles collide with the ridge portions. By this collision, the Cu base layer 30 at the ridge portions is ductility extended by the sandblasting. With such a configuration, the coverage ratio of the Cu base layer 30 at the ridge portions is improved. As a result, the coverage ratio of the Cu base layer 30 at the ridge portions approaches the coverage ratio of the Cu base layer 30 at portions other than the ridge portions. In this manner, uniformization of the coverage ratio of the Cu base layer 30 is achieved.

When describing the above processing step by step as a Cu base layer polishing method, it is as follows. That is, the Cu base layer polishing method includes a step of placing a pre-plating intermediate in which the Cu base layer 30 functioning as a portion of the external electrode is formed on the multilayer body 2 into a container, a step of rotating the container, and a step of spraying particles into the rotating container.

### Ni Plated Layer

Next, the Ni plated layer 31 is formed on the surface of the Cu base layer 30. The Ni plated layer 31 is formed by, for example, a barrel plating method.

### Sn Plated Layer

The Sn plated layer 32 is formed on the Ni plated layer 31. The Sn plated layer 32 is formed by, for example, a barrel plating method.

In this manner, multilayer ceramic capacitors are obtained.

### Method for Measuring Dimensions and Thickness

The dimensions and thickness of each portion can be obtained by performing cross-sectional polishing on the multilayer ceramic capacitor 1 or the multilayer body 2 as necessary, and measuring using a digital microscope or the like.

### Evaluation of Solder Leaching

After mounting the multilayer ceramic capacitor 1 of the present embodiment on a printed wiring board by solder bonding, the presence or absence of solder leaching was evaluated by observing a cross section of the multilayer ceramic capacitor 1. In the multilayer ceramic capacitor 1 of the present embodiment, solder leaching did not occur even from the heat during solder bonding.

Although embodiments of the present invention have been described above, the present invention is not limited to the above-described embodiments, and various changes and modifications thereto can be made.

### EXPLANATION OF REFERENCE NUMERALS

1 multilayer ceramic capacitor
2 multilayer body
4 inner layer dielectric layer
5 outer layer dielectric layer
6 first internal electrode layer
7 second internal electrode layer
41 first length direction ridge portion
42 second length direction ridge portion
43 third length direction ridge portion
44 fourth length direction ridge portion
45 first width direction ridge portion
46 second width direction ridge portion
47 first height direction ridge portion
48 second height direction ridge portion
57 inner layer portion
A1 coverage ratio of length direction ridge portion
A2 coverage ratio of width direction ridge portion
B1 coverage ratio of end surface
B2 coverage ratio of lateral surface
B3 coverage ratio of main surface

1. A multilayer ceramic capacitor comprising:
a multilayer body including a plurality of dielectric layers and a plurality of internal electrode layers that are laminated, a first main surface and a second main surface opposed to each other in a lamination direction, a first lateral surface and a second lateral surface opposed to each other in a width direction orthogonal to the lamination direction, and a first end surface and a second end surface opposed to each other in a length direction orthogonal to the lamination direction and the width direction; and
external electrodes respectively on the first end surface and the second end surface, wherein
each of the external electrodes includes a Cu base layer, a Ni plated layer in contact with the Cu base layer and covering the Cu base layer, and a Sn plated layer covering the Ni plated layer,
when portions where two surfaces of the multilayer body meet are each defined as a ridge portion,
a thickness of the Cu base layer at at least one ridge portion of the multilayer body is smaller than a thickness of the Cu base layer at a surface region of each of the main surfaces, the lateral surfaces and the end surfaces, wherein the surface region is spaced apart from any ridge portion,
a coverage ratio of the Cu base layer at the at least one ridge portion is 85% or more, and
a difference between the coverage ratio of the Cu base layer at the at least one ridge portion and a coverage ratio of the Cu base layer at each of the main surfaces and the lateral surfaces falls within ±5%.

2. The multilayer ceramic capacitor according to claim 1, wherein a thickness of the Ni plated layer at the ridge portion is 2.0 μm or more.

3. The multilayer ceramic capacitor according to claim 1, wherein a thickness of the Cu base layer at the ridge portion is 10 μm or more.

4. The multilayer ceramic capacitor according to claim 1, wherein the at least one ridge portion is a length direction ridge portion formed by an intersection of one of the main surfaces and one of the lateral surfaces.

5. The multilayer ceramic capacitor according to claim 1, wherein the at least one ridge portion is a width direction ridge portion formed by an intersection of one of the main surfaces and one of the end surfaces.

6. The multilayer ceramic capacitor according to claim 1, wherein the coverage ratios of the Cu base layer at the at least one ridge portion, the main surfaces, the lateral surfaces, and the end surfaces are all substantially equal.

7. The multilayer ceramic capacitor according to claim 1, wherein the coverage ratio of the Cu base layer at the at least one ridge portion is 95% or more.

8. The multilayer ceramic capacitor according to claim 1, wherein a difference between the coverage ratio of the Cu base layer at the at least one ridge portion and a coverage ratio of the Cu base layer at the end surfaces falls within ±5%.

9. The multilayer ceramic capacitor according to claim 1, wherein the Cu base layer includes a metal component and a glass component.

10. The multilayer ceramic capacitor according to claim 1, wherein the ridge portions of the multilayer body are rounded.

11. A method of manufacturing a multilayer ceramic capacitor, the method comprising:
forming a multilayer body having a plurality of surfaces and a plurality of ridge portions, wherein each ridge portion is an intersection of two of the plurality of surfaces;
applying an electrically conductive paste including Cu and a glass component to at least one end surface of the multilayer body to form a Cu base layer that extends over at least a portion of adjacent surfaces and ridge portions;
placing the multilayer body with the formed Cu base layer into a container;
rotating the container;
spraying particles into the rotating container to polish the Cu base layer, thereby increasing a coverage ratio of the Cu base layer at the ridge portions to be more uniform with a coverage ratio of the Cu base layer at the surfaces; and
forming a Ni plated layer on the polished Cu base layer and a Sn plated layer on the Ni plated layer.

12. A multilayer ceramic capacitor comprising:
a multilayer body including main surfaces, lateral surfaces, end surfaces, and ridge portions, wherein each ridge portion is an intersection of two of said surfaces; and
an external electrode on at least one of the end surfaces, the external electrode including a Cu base layer disposed on the multilayer body and a Ni plated layer disposed on the Cu base layer,
wherein a first ratio of a thickness of the Ni plated layer to a thickness of the Cu base layer, when measured at a ridge portion, is greater than a second ratio of the thickness of the Ni plated layer to the thickness of the Cu base layer, when measured at a surface region of one of the main surfaces or the lateral surfaces, wherein the surface region is spaced apart from any ridge portion.

13. The multilayer ceramic capacitor according to claim 12, wherein the ridge portion is a length direction ridge portion formed by an intersection of one of the main surfaces and one of the lateral surfaces.

14. The multilayer ceramic capacitor according to claim 12, wherein the ridge portion is a width direction ridge portion formed by an intersection of one of the main surfaces and one of the end surfaces.

15. The multilayer ceramic capacitor according to claim 12, wherein a difference between a coverage ratio of the Cu base layer at the ridge portion and a coverage ratio of the Cu base layer at the surface region falls within ±5%.
